(19) United States
(12) Patent Application Publication
(10) Pub. No.: US 2022/0279145 A1
(43) Pub. Date: Sep. 1, 2022

(54) METER reader, meter READING METHOD USING SAME, AND COMPUTER PROGRAM capable of PERFORMING METHOD

(71) Applicant: Meonggyu YOU, Anyang-si Gyeonggi-do (KR)

(72) Inventor: Meonggyu YOU, Anyang-si Gyeonggi-do (KR)

(21) Appl. No.: 17/432,074

(22) PCT Filed: Feb. 10, 2020
(86) PCT No.: PCT/KR2020/001851

§ 371 Date: May 15, 2022

(30) Foreign Application Priority Data
Feb. 19, 2019 (KR) 10-2019-0018974

(51) Int. Cl. H04N 7/18; H04N 5/232; G01D 4/00

(52) U.S. Cl. CPC H04N 7/183; H04N 7/188; H04N 5/232411; G01D 4/006

(57) ABSTRACT

A meter reader is provided. The meter reader includes a meter having an indicator for indicating a usage amount of fluid in numbers, a camera, a memory device, and a control circuit. The control circuit causes the camera to capture an image of the indicator and stores a captured indicator image in the memory device in response to a first interrupt generated at a first time every month, checks whether a day belongs to a meter reading period in response to a second interrupt generated at a second time every day, and transmits the indicator image stored in the memory device to a mobile device when the day belongs to the meter reading period and a connection signal transmitted from the mobile device is detected.

### TECHNICAL FIELD

The present invention relates to a fluid usage meter reader, and particularly to a meter reader capable of reading a usage amount of water, hot water, gas, or heat, a meter reading method using the same, and a computer program capable of performing the method.

### BACKGROUND ART

In general, in order to read an accumulated amount of an integration meter that displays a usage amount of electricity, gas, water, hot water, or heat, a meterman visually checks the accumulated amount on a predetermined date, calculates a cost by applying a rate on a rate table for the usage amount obtained by subtracting an accumulated amount of a previous month from the accumulated amount, and issues an invoice including the cost to a customer.

In a manual meter reading process, a lot of manpower is required, and meter reading is not easy due to errors in meter reading, rejection of meter reading, and the like. Moreover, it is almost impossible for all metermen to read all meters installed nationwide at the same time on the same day. Therefore, since each meterman reads meters installed in an area under his or her jurisdiction over several days, it is difficult to provide accurate statistics on nationwide flow rates.

Flow rate refers to a value obtained by dividing the amount of water to be charged (the amount of flowing water) by the total amount of water produced at a water purification plant and supplied (the total amount of water supplied) and expressed as a percentage, and water leaking into the ground (the amount of water leakage) is reduced as the flow rate increases.

### SUMMARY OF INVENTION

### Technical Problem

Once a meter reader such as a water meter reader is buried in the ground, it is difficult to take it out again, moisture and condensation are highly likely to occur if the meter reader is buried in the ground, and, since commercial power is not supplied to the meter reader, electronic devices included in the meter reader operate using a voltage of a battery included in the meter reader.

For this reason, a technical object of the present invention is to provide a meter reader that can remove moisture and condensation using a dehumidifying structure provided therein, and reduce power consumption of a battery provided therein using real-time clocks (RTCs) that generate interrupts.

A technical object of the present invention is to provide a meter reader devised to read a usage amount of water at a specific time on a specific date every month nationwide and provide accurate statistics on nationwide flow rates using a result of the reading, a meter reading method using the same, and a computer program capable of performing the method.

### Technical Solution

According to embodiments of the present invention, a meter reader includes a meter having an indicator for showing a usage amount of fluid in numbers, a camera, a memory device, and a control circuit that causes the camera to capture an image of the indicator and stores a captured indicator image in the memory device in response to a first interrupt generated at a first time every month, checks whether a day belongs to a meter reading period in response to a second interrupt generated at a second time every day, and transmits the indicator image stored in the memory device to a mobile device when the day belongs to the meter reading period and a connection signal transmitted from the mobile device is detected.

According to embodiments of the present invention, a meter reader includes a meter having an indicator displayed in numbers, a camera, a memory device, and a control circuit configured to calculate a date and a time by itself, control the camera such that the camera captures an image of the indicator at a predetermined time every month based on the calculated date and time to store the captured indicator image in the memory device, check whether a day belongs to a predetermined meter reading period at a predetermined time every day based on the calculated date and time, detect whether a connection signal is received from a mobile device when the day belongs to the meter reading period, and transmit the indicator image stored in the memory device to the mobile device when the connection signal is received.

According to embodiments of the present invention, a method of wirelessly providing meter reading data to a mobile device using a meter reader that includes a meter including an indicator for indicating a usage amount in numbers, a camera, a memory device and a control circuit includes causing, by the control circuit, the camera to capture an image of the indicator to store the captured indicator image in the memory device in response to a first interrupt generated at a first time every month, and checking, by the control circuit, whether a day belongs to a meter reading period in response to a second interrupt occurring at a second time every day, detecting whether a connection signal is received from the mobile device when the day belongs to the meter reading period, and transmitting the indicator image stored in the memory device and meter reader information on the meter reader to the mobile device when the connection signal is detected.

According to embodiments of the present invention, a computer program stored in a computer-readable recording medium for wirelessly providing meter reading data to a mobile device in combination with hardware, includes storing meter reader information in a memory device, switching to a first wakeup state from a sleep state in response to a first interrupt occurring at a first time every month, controlling a camera such that the camera captures an image of an indicator of a meter indicating a usage amount in numbers and generating an indicator image, receiving the indicator image generated by the camera and storing the indicator image in the memory device, entering the sleep state from the first wakeup state after the indicator image is stored in the memory device, switching from the sleep state to a second wakeup state in response to a second interrupt occurring at a second time every day, determining whether the day is a meter reading date based on the second interrupt, determining whether a connection signal is wirelessly received from the mobile device, determining whether a first time interval has elapsed when the day is not the meter reading date and the connection signal is not received to enter the sleep state from the second wakeup state when the first time interval has elapsed, reading the indicator image and the meter reader information from the memory device to transmit the indicator image and the meter reader information to the mobile device when the day is the meter reading date and the connection signal is received, and determining whether a second time interval has elapsed after the indicator image and the meter reader information are transmitted to the mobile device to enter the sleep state from the second wakeup state when the second interval time has elapsed.

### Advantageous Effects of Invention

A meter reader according to an embodiment of the present invention can remove moisture and condensation using a dehumidifying structure provided therein and reduce power consumption of a battery using real-time clocks (RTCs) that generate interrupts.

A meter reader, a meter reading method using the same, and a computer program capable of performing the method according to an embodiment of the present invention can read a usage amount of fluid (for example, water) at a specific time on a specific date every month nationwide and store a result of the meter reading as an image, and thereby it is possible to accurately provide statistics on nationwide flow rates by using the meter reader and the meter reading method.

### BRIEF DESCRIPTION OF DRAWINGS

FIGS. 1 and 2 are schematic diagrams of a meter reader according to an embodiment of the present invention.

FIG. 3 shows a block diagram of a meter reading system that includes the meter reader and a mobile device according to the embodiment of the present invention;

FIG. 4 is a flowchart that describes an operation of the meter reader shown in FIG. 3;

FIG. 5A shows a packet transmitted between the meter reader and the mobile device,

FIG. 5B shows a definition of the packet, FIG. 5C is an embodiment of a request packet, and FIG. 5D is an embodiment of a response packet.

FIG. 6 is a data flow that describes an operation of an application for processing meter reading data, executed on the mobile device; and

FIG. 7 is a flowchart that describes an operation of the meter reader shown in FIG. 3.

### BEST MODE

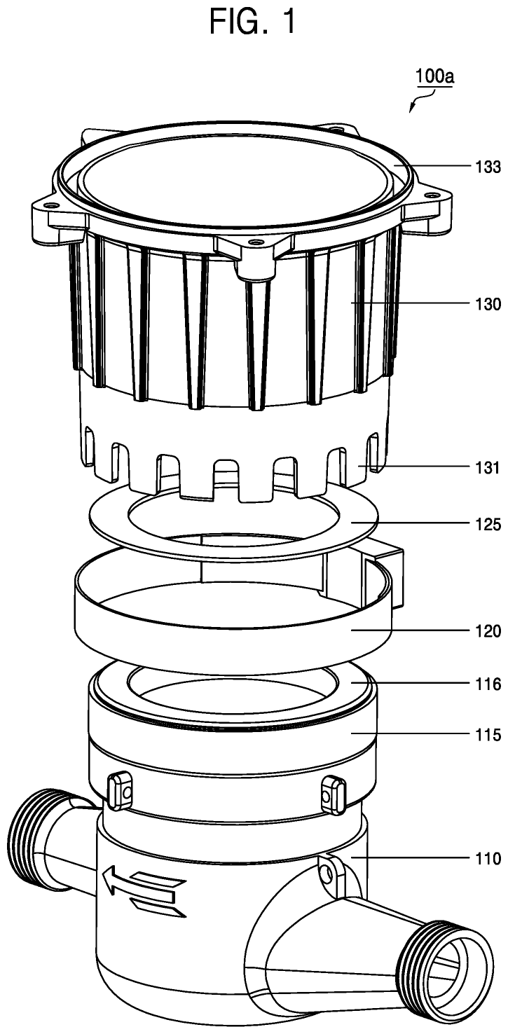

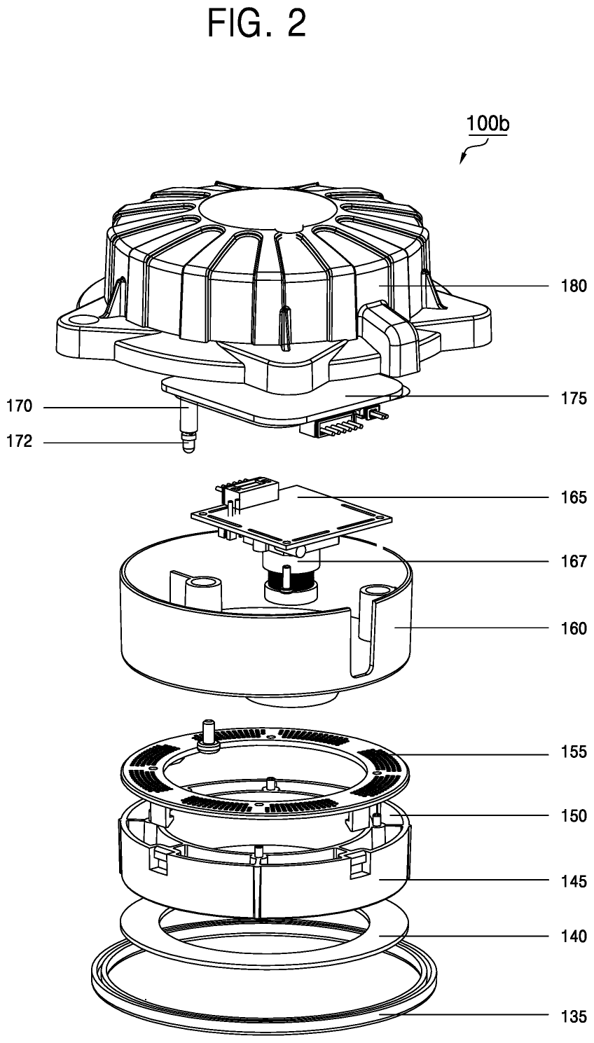

In FIGS. 1 and 2, a water meter is shown and described as an example of a mechanical meter, but a meter reader 100 having components shown in FIG. 3 may be used as a meter reader that includes an integration meter that mechanically (for example, using an indicator for showing a usage amount in numbers) indicates the usage amount of electricity, gas, water, hot water, or heat.

FIGS. 1 and 2 are schematic diagrams of a meter reader according to an embodiment of the present invention. 100a shows a lower part of the schematic diagram of a meter reader, and 100b shows an upper part of the schematic diagram of the meter reader. The meter reader 100 includes a meter 110 having an indicator 112 for showing a usage amount of fluid (for example, gas or liquid) in numbers. Since the meter reader 100 is buried in the ground, it needs to be strong for sealing and water proofing, and moisture and condensation of the meter reader 100 buried in the ground need to be removed. The meter reader 100 according to the present invention has a structure for sealing, waterproofing, and removing moisture and condensation.

A rubber band 115 is used for waterproofing and sealing when a lower part 131 of a chamber 130 is fitted (or inserted) to an upper part of the meter 110, and a hose band 120 is used to tightly tighten the lower part 131 of the chamber 130 fitted (or inserted) on the rubber band 115.

A first adhesive material (for example, a first foam tape) 125 is used to bond an upper surface 116 of the meter 110 and component (for example, a second adhesive material 140) disposed inside the chamber 130. Components 140, 145, and 155 are inserted into the chamber 130. A sealing material (for example, a rubber O-ring) 135 is inserted into a concave portion 133 of an upper part of the chamber 130, and is used for waterproofing and sealing when the chamber 130 and a cover 180 are combined.

A second adhesive material (for example, a second foam tape) 140 is used to bond the first adhesive material (for example, the first foam tape) 125 and a silicon bottom 145.

A dehumidifying structure includes the silicon bottom 145 and a silicon top 155, and a dehumidifier (for example, silica gels) is stored in a storage space 150 formed between the silicon bottom 145 and the silicon top 155. After the chamber 130 and the cover 180 are combined, moisture and condensation may occur in a space between the chamber 130 and the cover 180. At this time, the dehumidifier inserted into the storage space 150 may remove the moisture and the condensation.

A camera cover 160 disposed on the silicon top 155 includes a camera 167 and a camera printed circuit board (PCB) assembly 165. Electronic elements for controlling an operation of the camera 167 are formed in the camera PCB assembly 165.

A PCB assembly 175 performing a function of a control circuit 200 is disposed on or above the camera PCB assembly 165, and the PCB assembly 175 is connected to at least one LED 172 through a light emitted diode (LED) guide 170. The at least one LED 172 is used for illumination of the camera 167 when the camera 167 performs an image capturing operation. The cover 180 is disposed over the PCB assembly 175.

FIG. 3 shows a block diagram of a meter reading system that includes a meter reader and a mobile device according to the embodiment of the present invention. Referring to FIGS. 1 and 3, the meter reader 100 includes a meter (for example, a mechanical meter) 110 having an indicator 112 for showing a usage amount of fluid in numbers, the camera 167, a memory device 300 and the control circuit 200. The camera 167, the memory device 300, and the control circuit 200 may perform a function of an automatic recording device that automatically records a usage amount of fluid.

The camera 167 is attached to the camera PCB assembly 165 of FIG. 2 and generates an indicator image IM for the indicator 112 by capturing an image of the indicator 112.

The memory device 300 stores the indicator image IM under control of the control circuit 200. The control circuit 200 may delete a previous indicator image for the indicator 112 captured at a first time of the last (or previous) month before storing an indicator image for the indicator 112 captured at the first time of this month in the memory device 300. Here the first time may refer to month, day, and hour, minute, and second. The memory device 300 may be a non-volatile memory device.

In this specification, an embodiment is described in which an indicator image for the indicator 112 is stored in the memory device 300 for a month, but the indicator image for the indicator 112 may be stored in the memory device 300 for two months or more and then deleted before an indicator image captured this month is stored according to user's settings of the mobile device 400 (for example, settings using an app (or an application) 410 installed on the mobile device 400).

For example, the mobile device 400 may refer to a smartphone, a personal digital assistant (PDA), a laptop computer, a mobile internet device (MID), or a wearable device.

The control circuit 200 may refer to a set of electronic elements disposed on the PCB assembly 175 of FIG. 2, and the control circuit 200 may cause the camera 167 to capture an image of the indicator 112 of the meter 110 and receive an indicator image IM including the captured image of the indicator 112 to store the indicator image IM in the memory device 300 in response to a first interrupt INT1 generated at a first time every month (for example, at 0:00 AM on a first day of each month), check whether a day belongs to a meter reading period in response to a second interrupt INT2 generated at a second time every day (for example, at 9:00 AM every day), and read meter reader information INF and the indicator image IM stored in the memory device 300 to transmit these (IM and INF) to the mobile device 400 when the day belongs to the meter reading period and a connection signal CS transmitted from the mobile device 400 is detected.

The meter reading period may refer to one day or two or more days and, if a meter reading date is the 10^{th} of each month, the meter reading period may be set to be from the 9^{th} to the 11^{th} of each month.

For example, the control circuit 200 maintains a connection standby state for a first connection standby time (for example, 9 hours) after waking up by the second interrupt INT2 generated at a second time in a set meter reading period (for example, the 9^{th}, 10^{th}, and 11^{th}), and automatically enters a sleep state when the first connection standby time elapses, and the control circuit 200 maintains a connection standby state during a second connection standby time (for example, 2 hours) after waking up by the second interrupt INT2 generated at the second time in a period other than the set meter reading period, and automatically enters the sleep state when the second connection standby time elapses. Here, the first connection standby time may be set to be longer than the second connection standby time.

Each of all meter readers at a first time every month generates an indicator image by capturing an image of an indicator of a meter included in each of all the meter readers and stores it in the memory device for the purpose of improving a flow rate.

Since each of a first group of meter readers that are subject to meter reading in a meter reading period among all meter readers in the meter reading period maintains a connection standby state only during a first connection standby time, a meterman may perform meter reading on each of the first group of meter readers during the first connection standby time.

In addition, since each of a second group of meter readers that do not correspond to a meter reading period among all the meter readers maintains a connection standby state only during a second connection standby time, a meterman may perform meter reading on a meter reader with a special reason (for example, an omission of meter reading, moving of owner of meter reader, or the like) occurred among the second group of meter readers during the second connection standby time.

With one meter reader cited as an example, the meter reader goes to sleep after a certain period of time (for example, 2 minutes) has elapsed after waking up at a first time every month, goes to sleep after a first connection standby time has elapsed after waking up at a second time every day in a set meter reading period, and goes to sleep after a second connection standby time has elapsed after waking up at a third time every day in a period other than the meter reading period. According to embodiments, the second time and the third time may be set to be the same or set to be different from each other.

A user of the mobile device 400 may set a meter reading period using the app 410. Moreover, a meter reading date may refer to a meter reading period as well as a day of the meter reading date.

Meter reader information INF may include a name and an address of a customer (or consumer), a meter reader installation date, a meter reader unique number (for example, a meter reader device number), a customer number, and/or state information on a battery 250 (for example, a battery level). According to embodiments, a date when an indicator image IM is captured may be included in the indicator image IM or may be included in the meter reader information INF.

Meter reader information INF corresponding to wireless meter reader information RF_INF transmitted from the mobile device 400 may be stored in the memory device 300 by the control circuit 200, and wireless meter reader information RF_INF corresponding to the meter reader information INF stored in the memory device 300 may be transmitted to the mobile device 400 by the control circuit 200.

Even though it is displayed in FIG. 3 that the wireless meter reader information RF_INF transmitted from the mobile device 400 and the wireless meter reader information RF_INF transmitted to the mobile device 400 are the same, the wireless meter reader information RF_INF transmitted from the mobile device 400 and the wireless meter reader information RF_INF transmitted to the mobile device 400 may be different from each other according to embodiments.

For example, when a meterman (technical researcher) carrying the mobile device 400 approaches near the meter reader 100, the wireless transceiver 240 of the control circuit 200 may detect a wireless connection signal RF_CS output from the mobile device 400, and read an indicator image IM and meter reader information INF from the memory device 300 according to a result of the detection (for example, a connection signal CS) to transmit the indicator image IM and the meter reader information INF to the mobile device 400.

The control circuit 200 includes a controller 210, a first real time clock (RTC) 220, a second RTC 230, a wireless transceiver 240, a battery 250, and power generators 260. According to an embodiment, the control circuit 200 may further include a light source 172, the light source 172 may include at least one LED, and the light source 172 may also be electrically connected to the control circuit 200 through an LED guide 170. The light source 172 performs a function of a flash of the camera 167.

Since the control circuit 200 includes RTCs 220 and 230 performing a clock function, it may recognize (or calculate) a first time and a second time by itself. According to embodiments, a time (or a time point) of each of the RTCs 220 and 230 may be updated according to time (or time point) information included in a connection signal CS. Since the RTCs 220 and 230 included in the meter reader 100 buried in the ground may be degraded over time, the time of each of the RTCs 220 and 230 may be inaccurate over time. The time of each of the RTCs 220 and 230 is synchronized with a time used by the mobile device 400. The control circuit 200 may control a wakeup timing and a sleep timing according to each of the RTCs 220 and 230.

According to embodiments, when a computer program 212 of the control circuit 200 includes a software timer, even if the RTCs 220 and 230 are not implemented in the control circuit 200, the control circuit 200 may perform operations of the meter reader 100 described herein by recognizing (or calculating) a first time and a second time by itself using the software timer.

The controller 210 may control an image capturing operation of the camera 167, control functions of the control circuit 200, and a read operation and a write operation of the memory device 300.

The controller 210 may be a central processing unit (CPU) or a main (or micro) control unit (MCU). The controller 210 may perform the following operations.
(i) A generation and storage mode (or storage operation) for generating and storing an indicator image IM based on a first interrupt INT1,
(ii) a recognition mode (or recognition operation) for recognizing the mobile device 400 on the basis of a connection signal CS, and
(iii) a transmission mode (or transmission operation) for transmitting the indicator image IM and meter reader information INF to the mobile device 400 on the basis of a second interrupt INT2 may be performed. The recognition mode may be performed in a meter reading period.

According to the embodiments, when the control circuit 200 further includes a forced recognition button 310, if a meterman fails to read the meter reader 100 within a first time or a meter reading period, and the meterman opens a lid of a meter reader box embedded with the meter reader 100 to press the forced recognition button 310 installed in the control circuit 200, the control circuit 200 may recognize the mobile device 400 on the basis of a transmission request signal generated by the forced recognition button 310 being pressed, and transmit the indicator image IM and the meter reader information INF stored in the memory device 300 to the mobile device 400.

The controller 210 executes the computer program 212, and the computer program 212 may perform a switching from a wakeup state to a sleep state in response to an interrupt INT1 or INT2, control of an image capturing operation of the camera 167, turning on or off of the light source 172, determination on whether a specific time (for example, a first time, a second time, a first connection standby time, and/or a second connection standby time) has elapsed for switching from the wakeup state to the sleep state, determination on whether a connection signal CS is detected, synchronization between time information included in the connection signal CS and time information of each of the RTCs 220 and 230, an operation of storing the indicator image IM and/or the meter reader information INF in the memory device 300, an operation of reading the indicator image IM and/or the meter reader information INF from the memory device 300, and/or an operation of deleting an indicator image captured in a previous month.

When a first RTC 220 generates a first interrupt INT1 at a first time every month and transmits the first interrupt INT1 to the controller 210, a state of the controller 210 switches from a sleep state to a wakeup state in response to the first interrupt INT1, and the controller 210 controls the camera 167 such that it generates an indicator image IM. Here, the controller 210 turns on the light source 172 to capture an image of the indicator 112 and turns off the light source 172 after the image of the indicator 112 is captured.

The first RTC 220 and the controller 210 may transmit and receive signals (for example, commands or data) through Inter-Integrated Circuit (I2C) communication, and the controller 210 may set a first time and a time to return to the sleep state in the first RTC 220 through the I2C communication, or may perform time synchronization with the mobile device 400 as described above.

When the second RTC 230 generates a second interrupt INT2 at a second time every day and transmits the second interrupt INT2 to the controller 210, the state of the controller 210 switches from a sleep state to a wakeup state in response to the second interrupt INT2, determines whether today (a wake-up day) is a meter reading date or belongs to a meter reading period, and reads the indicator image IM stored in the memory device 300 to transmit it to the mobile device 400 when today is a meter reading date or belongs to a meter reading period.

As described above, a meter reading period may refer to a short period including a meter reading date, and the meter reading period may be the 9^{th}, 10^{th}, and 11^{th} of each month on an assumption that the meter reading date is the 10^{th} of each month, but the meter reading period is not limited thereto. The second RTC 230 and the controller 210 may transmit and receive signals through the I2C communication, and the controller 210 may set a second time, a first connection standby time, and/or a second connection standby time in the second RTC 230 through the I2C communication or perform time synchronization with the mobile device 400 as described above.

As described above, the first RTC 220 is required to generate an indicator image IM, and the second RTC 230 is required to transmit the indicator image IM. In addition, the first RTC 220 and the second RTC 230 are required to reduce power consumption of the battery 250.

The wireless transceiver 240 may interface or convert a signal transmitted or received between the controller 210 and the mobile device 400. For example, the wireless transceiver 240 may generate a connection signal CS and/or meter read information INT corresponding to a wireless connection signal RF_CS and/or wireless meter reader information RF_INT transmitted from the mobile device 400 to transmit a result of the generation to the controller 210, or generate a wireless indicator image RF_IM and/or wireless meter reader information RF_INT corresponding to an indicator image IM and/or meter reader information INT transmitted from the controller 210 to transmit a result of the generation to the mobile device 400. For example, the wireless transceiver 240 may transmit or receive signals to or from the mobile device 400 according to a Bluetooth communication protocol or a Bluetooth Low Energy (BLE) communication protocol.

The battery 250 may supply an operation voltage to the power generators 260, and the power generators 260 may include voltage generators that generate voltages required for operations of each constituent 167, 172, 210, 220, 230, 240, or 300.

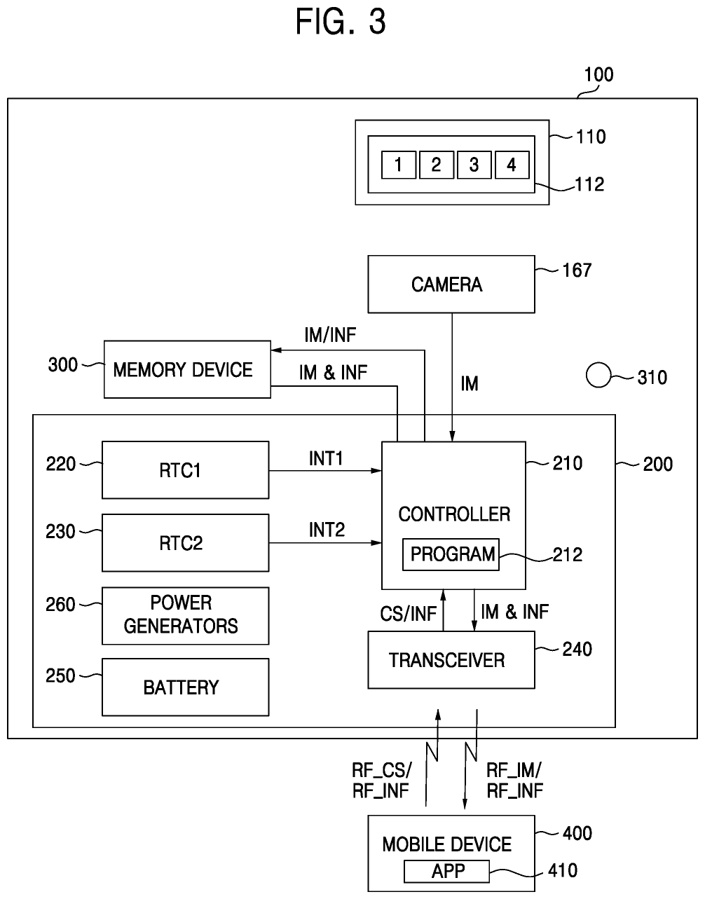

FIG. 4 is a flowchart that describes an operation of the meter reader shown in FIG. 3. Referring to FIGS. 1 to 4, it is assumed that the meter reader 100 except for the RTCs 220 and 230 operates in a sleep state (S110).

The controller 210 or the computer program 212 switches from a sleep state to a wakeup state in response to the first interrupt INT1 generated by the first RTC 220 at a first time every month (S115), and the controller 210 in the wakeup state or the computer program 212 causes the camera 167 to capture an image of an indicator 112, and receives the captured indicator image IM1 to store it in the memory device 300 (S120).

When a predetermined time (for example, 2 minutes) elapses after the indicator image IM1 is stored in the memory device 300, the controller 210 or the compute program 212 enters the sleep state from the wakeup state to reduce the power consumption of the battery 250 (S125).

The controller 210 or the computer program 212 switches from the sleep state to the wakeup state in response to the second interrupt INT2 generated by the second RTC 230 at a second time every day (S130). The controller 210 in the wakeup state or the computer program 212 checks (or determines) whether a day belongs to a meter reading period (S135).

When the day does not belong to the meter reading period (NO in step S135), the controller 210 or the computer program 212 detects whether a connection signal CS is received from the mobile device 400 within a first time interval (or a second connection standby time) (S140), and, if the connection signal CS is not received (or detected) within the first time interval (or the second connection standby time) (NO in S140), the controller 210 or the computer program 212 enters the sleep state from the wakeup state to reduce the power consumption of the battery 250 (S125).

However, when the connection signal CS is received (or detected) within the first time interval (YES in S140), the controller 210 or the computer program 212 reads an indicator image IM and meter reader information INF from the memory device 300 to transmit the indicator image IM and the meter reader information INF to the wireless transceiver 240, and then enters the sleep state (S155).

Although FIG. 4 shows that a step of S160 is performed after the connection signal CS is received within the first time interval (YES in S140), the controller 210 or the computer program 212 may enter the sleep state immediately after the step (S155) is performed to reduce the power consumption of the battery 250 (S155).

The wireless transceiver 240 transmits a wireless indicator image RF_IM and wireless reader information RF_INF corresponding to the indicator image IM and the meter reader information INF to the mobile device 400.

When the day belongs to the meter reading period (YES in S135), the controller 210 or the computer program 212 waits to receive the connection signal CS transmitted from the mobile device 400 during a first connection standby time (S145).

When the connection signal CS is not received (or detected) during the first connection standby time (NO in S150), the controller 210 or the computer program 212 performs the step of S135.

When the connection signal CS is received (or detected) during the first connection standby time (YES in S150), the controller 210 or the computer program 212 reads the indicator image IM and the meter reader information INF from the memory device 300, and transmits the indicator image IM and the meter reader information INF to the wireless transceiver 240 (S155). As a result, the wireless transceiver 240 transmits a wireless indicator image RF_IM and wireless meter reader information RF_INF corresponding to the indicator image IM and the meter reader information INF to the mobile device 400.

After the indicator image IM and the meter reader information INF are transmitted to the wireless transceiver 240 or the mobile device 400, the controller 210 or the computer program 212 determines whether a second time (for example, a first connection standby time when the day belongs to a meter reading period, or a second connection standby time when the day does not belong to the meter reading period) has elapsed after the transmission, and enters the sleep state from the wakeup state to reduce the power consumption of the battery 250 when the second time has elapsed (S160).

Even if a meterman reading the meter reader 100 loses meter reading data (for example, the indicator image IM and/or the meter reader information INF) due to a defect in the mobile device 400 or his or her own mistake, since the meter reader 100 maintains the wakeup state for the second time, the meterman may receive the meter reading data (for example, the indicator image IM and/or the meter reader information INF) from the meter reader 100 again within the second time.

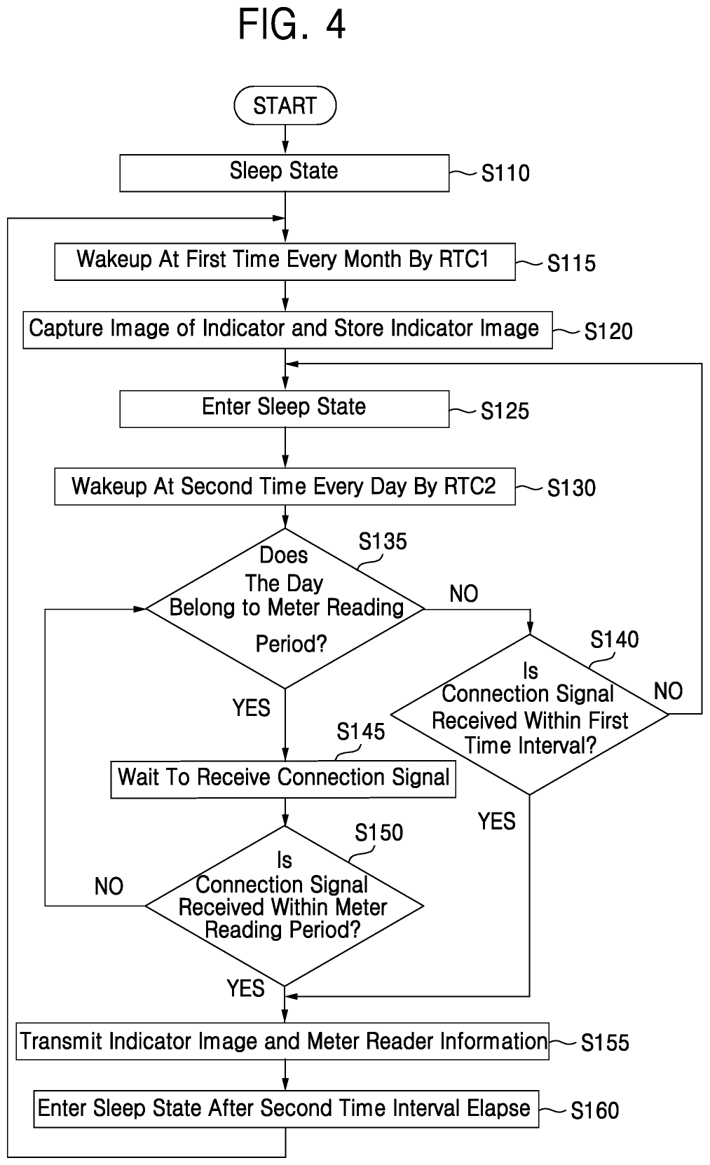

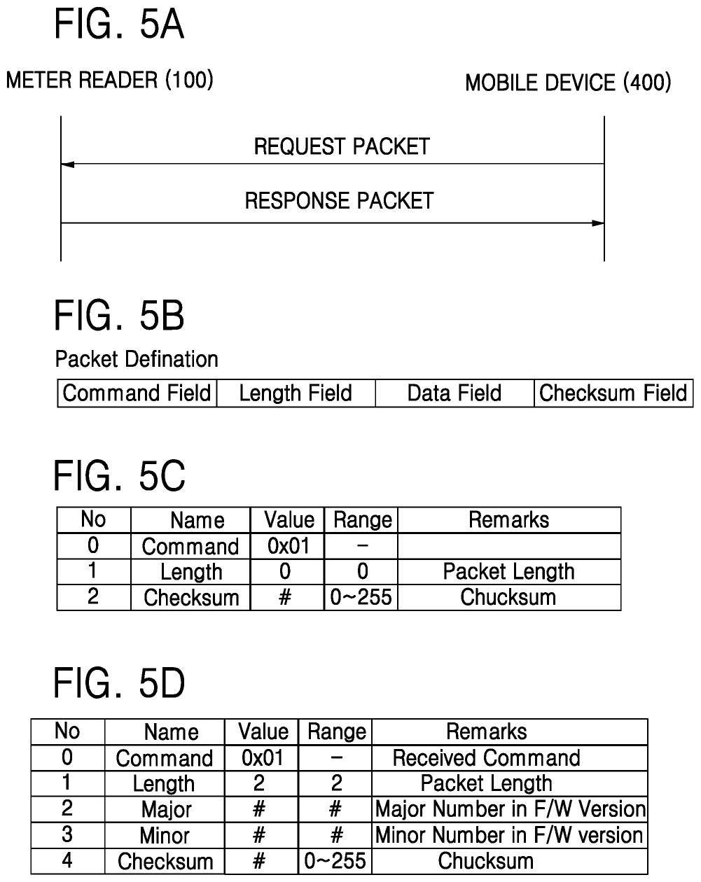

FIG. 5A shows a packet transmitted between a meter reader and a mobile device, FIG. 5B shows a definition of the packet, FIG. 5C is an embodiment of a request packet, and FIG. 5D is an embodiment of a response packet.

Referring to FIG. 5A, when the mobile device 400 transmits a request packet to the meter reader 100 wirelessly or using BLE, the meter reader 100 transmits a response packet to the request packet to the mobile device 400 wirelessly or using BLE.

Referring to a packet exemplarily shown in FIG. 5B, a packet (a request packet or a response packet) includes a command (or a code) field, a length field, a data field, and a checksum field.

Referring to FIGS. 5C and 5D, a response packet includes a command value of a request packet. For example, the request packet may include a command to request transmission of the computer program 212 in a firmware version, a command to request a firmware upgrade, a command to request setting of a first time point and/or a second time point, a command to request setting of a first time and/or a second time, a command to request transmission of a battery state, a command to request setting (or transmission) of a device number, a command to request setting (or transmission) of a customer number, a command to request setting (or transmission) of an indicator image-capturing time, a command to request setting of a meter reading period, or a command to request transmission of set time information (for example, a first time point, a second time point, a first time, a second time, a first connection standby time, a second connection standby time, or a meter reading period).

The controller 210 or the computer program 212 receives a request packet including a command and first data from the mobile device 400 to perform an operation corresponding to the command, generates a response packet including the command and second data corresponding to a result of performing the operation, and transmits the response packet to the mobile device 400. For example, the first data may include length data included in the length field, data included in the data field, and a checksum included in the checksum field, and the second data may include length data included in the length field, data included in the data field, a checksum included in the checksum field, and result data corresponding to a result of performing the operation.

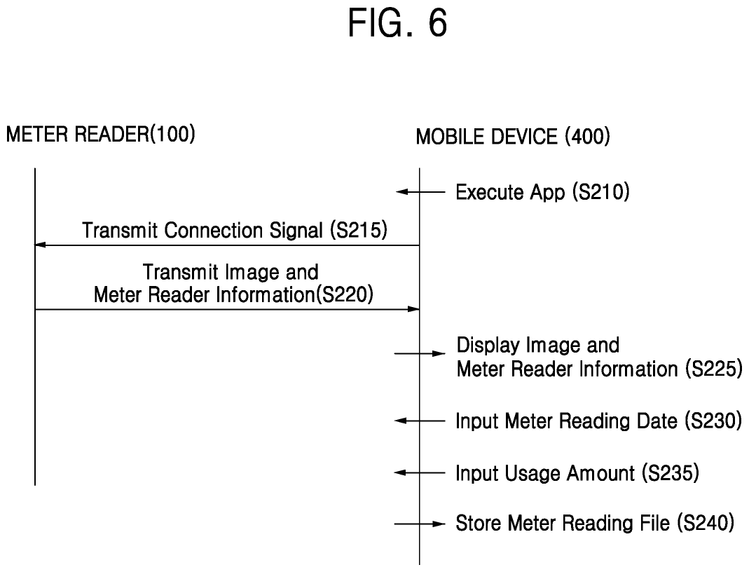

FIG. 6 is a dataflow that describes an operation of an app for processing meter reading data, executed on the mobile device.

A meterman execute an app (collectively refer to an application, an application program, or a mobile application) 410 that is installed on the mobile device 400 (S210). The app 410 sets meter reader information INF in the meter reader 100, receive and process meter reading data. The app 410 transmits a wireless connection signal RF_CS to the meter reader 100 (S215). The control circuit 200 or the computer program 212 of the meter reader 100 transmits meter reading data (for example, a wireless meter reading image RF_IM and wireless meter reader information RF_INF corresponding to a meter reading image IM and meter reader information INF) to the app 410 of the mobile device 400 (S220). Here, an app transmitting or receiving signals means that the app transmits or receives signals to or from the meter reader 100 through a wireless transceiver included in the mobile device 400.

The app 410 displays the meter reading data (for example, the meter reading image IM and the meter reader information INF) on a display device of the mobile device 400 (S225). The meter reading image IM is raw data.

A meterman inputs a meter reading date on which the meter reading data is received from the app 410 (S230). The meterman inputs numbers indicated by an indicator included in the displayed meter reading image IM to a numerical graphical user interface (GUI) of the app 410 as a usage amount (S235). The app 410 generates a meter reading file and stores it in a memory device of the mobile device 400.

The meter reading file includes a meter reading date, a customer number, a device number, a customer name, an address of the customer, a usage amount, a date on which an indicator image IM is generated, and the indicator image IM. The app 410 may store the meter reading file in the memory device of the mobile device 400 in a form of a comma-separated values (CSV) file.

According to embodiments, the meter reading date and a usage amount may be automatically generated by the app 410 to be input to the meter reading file, or a meterman may input it to the file by himself.

In combination of hardware (for example, 200 or 210), the computer program 212 that may be read by a computer (for example, 200 or 210) may be stored in a recording medium (for example, 210 or 300) to wirelessly provide the meter reading data (for example, the indicator image IM and the meter reader information INF) to the mobile device 400. The computer program 212 stored in the memory device 300 may be executed after being loaded to the controller 210 by the controller 210. Moreover, the computer program 212 embedded in the controller 210 may be executed by the controller 210.

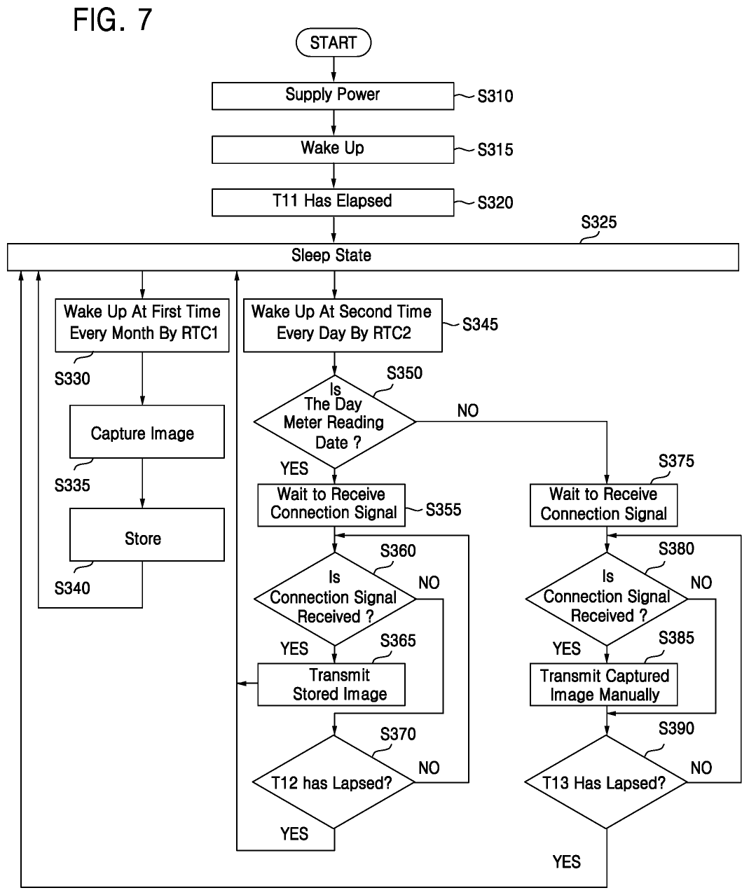

FIG. 7 is a flowchart that describes an operation of the meter reader shown in FIG. 3. Referring to FIGS. 1 to 7, when a power supply (or an operation voltage) is supplied to the meter reader 100 (S310), the meter reader 100 wakes up from a sleep state (S315), and the meter reader 100 enters the sleep state when a second wakeup time T11 (for example, 2 minutes) has elapsed (S320).

The controller 210 or the computer program 212 switches from the sleep state to the wakeup state in response to a first interrupt INT1 generated by the first RTC 220 at a first time every month (S330), the controller 210 in the wakeup state or the computer program 212 causes the camera 167 to capture an image of an indicator 112 (S335) and receives a captured indicator image IM1 to store it in the memory device 300 (S340), and the controller 210 or the computer program 212 enters the sleep state from the wakeup state when a predetermined time (for example, 2 minutes) has elapsed after the indicator image IM1 is stored in the memory device 300.

The controller 210 or the computer program 212 switches from the sleep state to the wakeup state in response to a second interrupt INT2 generated by the second RTC (230) at a second time every day (S345), and the controller 210 in the wakeup state or the computer program 212 checks (or determines) whether the day belongs to a meter reading period (S350).

When the day belongs to the meter reading period (YES in S350), the controller 210 or the computer program 212 waits to receive a connection signal CS transmitted from the mobile device 400 (S355).

When the connection signal CS is received (or detected) (YES in S360), the controller 210 or the computer program 212 reads an indicator image stored in the memory device 300 to transmit it to the mobile device 400 (S365), and enters the sleep state when the transmission is completed (S325).

When the connection signal CS is not received (or detected) (NO in S360), the controller 210 or the computer program 212 determines whether the first connection standby time (T12) has elapsed (S370).

When the connection signal CS is not received (or detected) (NO in S360), and the first connection standby time (T12) has elapsed (YES in S370), the controller 210 or the computer program 212 enters the sleep state (S325).

However, when the connection signal CS is not received (or detected) (NO in S360), and the first connection standby time (T12) has not elapsed (NO in S370), the controller 210 or the computer program 212 performs the step of S360.

When the day does not belong to the meter reading period (NO in S350), the controller 210 or the computer program 212 waits to receive a connection signal CS transmitted from the mobile device 400 (S375).

When the connection signal CS is received (YES in S380), the controller 210 or the computer program 212 generates an indicator image by capturing an image of an indicator 112 manually (for example, according to control of the app 410), transmits the indicator image to the mobile device 400 (S385), determines whether the second connection standby time (T13) has elapsed (S390), and enters the sleep state when the second connection standby time (T13) has elapsed (YES in S390) (S325).

According to the embodiments, the controller 210 or the computer program 212 may enter the sleep state immediately after the step of S385 is performed (S325).

When the connection signal CS is not received (NO in S380), the controller 210 or the computer program 212 performs the step of S390. When the connection signal CS is received (YES in S380), and the second connection standby time (T13) has not elapsed (NO in S390), the controller 210 or the computer program 212 performs the step of S380.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

### INDUSTRIAL APPLICABILITY

The present invention may be applied to a meter reader, a meter reading method using the same, and a computer program capable of performing the method.

What is claimed is:

1. A meter reader comprising:
a meter having an indicator for showing a usage amount of fluid in numbers;
a camera;
a memory device; and
a control circuit that causes the camera to capture an image of the indicator to store a captured indicator image in the memory device in response to a first interrupt generated at a first time every month, checks whether a day belongs to a meter reading period in response to a second interrupt generated at a second time every day, and transmits the indicator image stored in the memory device to a mobile device when the day belongs to the meter reading period and a connection signal transmitted from the mobile device is detected.

2. The meter reader of claim 1, wherein the control circuit includes,
a first real time clock (RTC) configured to generate the first interrupt;
a second RTC configured to generate the second interrupt; and
a controller,
wherein the controller wakes up from a sleep state in response to the first interrupt generated by the first RTC, switches to the sleep state after the indicator image is stored in the memory device, wakes up again from the sleep state in response to the second interrupt generated by the second RTC, switches to the sleep state after a first time interval elapses when the day does not belong to the meter reading period, and switches to the sleep state after a second time interval elapses after transmitting the indicator image to the mobile device when the day belongs to the meter reading period and the connection signal is detected, and
the first time interval is shorter than the second time interval.

3. The meter reader of claim 2, wherein the controller switches to the sleep state after transmitting the indicator image to the mobile device when the connection signal is detected within the first time interval.

4. The meter reader of claim 2, wherein the control circuit further includes a wireless transceiver that detects the connection signal and transmits the indicator image to the mobile device.

5. The meter reader of claim 4, further comprising a battery,
wherein the memory device stores the indicator image, information on a date when the indicator image is captured, state information of the battery generated by the controller, and an identification number of the meter reader, and
the controller transmits the information on a date, the state information of the battery, and the identification number of the meter reader along with the indicator image to the mobile device through the wireless transceiver when the day belongs to the meter reading period and the connection signal is detected by the wireless transceiver.

6. The meter reader of claim 1,
wherein the control circuit deletes an indicator image for the indicator captured in a previous month from the memory device before storing the indicator image captured this month in the memory device.

7. The meter reader of claim 1,
wherein the control circuit receives a request packet including a command code and first data from the mobile device to perform an operation corresponding to the command code, generates a response packet including the command code and second data corresponding to a result of performing the operation, and transmits the response packet to the mobile device.

8. A meter reader comprising:
a meter having an indicator displayed in numbers;
a camera;
a memory device; and
a control circuit configured to calculate a date and a time by itself, control the camera such that the camera captures an image of the indicator at a predetermined time every month based on the calculated date and time to store the captured indicator image in the memory device, check whether a first day belongs to a predetermined meter reading period at a predetermined time every day based on the calculated date and time, detect whether a connection signal is received from a mobile device when the first day belongs to the predetermined meter reading period, and transmit the indicator image stored in the memory device to the mobile device when the connection signal is received.

9. The meter reader of claim 8,
wherein the control circuit calculates the date and the time by itself using real time clocks (RTCs).

10. The meter reader of claim 8,
wherein the control circuit causes the meter reader to enter a sleep state when the first day does not belong to the predetermined meter reading period and the connection signal is not detected during a first time interval.

11. The meter reader of claim 10,
wherein the control circuit causes the meter reader to enter the sleep state when a second time interval elapses after transmitting the indicator image to the mobile device.

12. A method of wirelessly providing meter reading data to a mobile device using a meter reader that includes a meter having an indicator for indicating a usage amount in numbers, a camera, a memory device and a control circuit, the method comprising:
causing, by the control circuit, the camera to capture an image of the indicator to store a captured indicator image in the memory device in response to a first interrupt generated at a first time every month; and
checking, by the control circuit, whether a first day belongs to a meter reading period in response to a second interrupt generated at a second time every day, detecting whether a connection signal is received from the mobile device when the first day belongs to the meter reading period, and transmitting the indicator image stored in the memory device and meter reader information on the meter reader to the mobile device when the connection signal is detected.

13. The method of claim 12, further comprising:
checking, by the control circuit waking up in response to the first interrupt, whether the connection signal is detected during a first time interval after the control circuit wakes up even if the first day is not the meter reading period; and
switching, by the control circuit, from a wake-up state to a sleep state when the connection signal is not detected during the first time interval.

14. The method of claim 13, further comprising:
switching, by the control circuit waking up in response to the second interrupt, to the sleep state after transmitting the indicator image and the meter reader information to the mobile device when the connection signal is detected even if the first day does not belong to the meter reading period.

15. The method of claim 13, further comprising:
switching, by the control circuit waking up in response to the second interrupt, to the sleep state when a second time interval elapses after transmitting the indicator image and the meter reader information to the mobile device,
wherein the first time interval is shorter than the second time interval.

16. The method of claim 12, further comprising:
displaying, an application executed on the mobile device, the indicator image and the meter reader information; and
storing, by the application, the usage amount and the meter reader information when the amount of use corresponding to the numbers included in the indicator image is input to the application by a user of the mobile device,
wherein the meter reader information includes information on a date when the indicator image is captured, and an identification number of the meter reader.

17. A computer program stored in a computer-readable recording medium for wirelessly providing meter reading data to a mobile device in combination with hardware, comprising:
storing meter reader information in a memory device;
switching from a sleep state to a first wakeup state in response to a first interrupt generated at a first time every month;
controlling a camera such that the camera captures an image of an indicator of a meter indicating a usage amount in numbers to generate an indicator image;
receiving the indicator image generated by the camera to store the indicator image in the memory device;
entering the sleep state from the first wakeup state after the indicator image is stored in the memory device;
switching from the sleep state to a second wakeup state in response to a second interrupt generated at a second time every day;
determining whether a first day is a meter reading date based on the second interrupt;
determining whether a connection signal is wirelessly received from the mobile device;
determining whether a first time interval has elapsed when the first day is not the meter reading date and the connection signal is not received to enter the sleep state from the second wakeup state when the first time interval has elapsed;
reading the indicator image and the meter reader information from the memory device to transmit the indicator image and the meter reader information to the mobile device when the first day is the meter reading date and the connection signal is received; and
determining whether a second time interval has elapsed after the indicator image and the meter reader information are transmitted to the mobile device to enter the sleep state from the second wakeup state when the second time interval has elapsed.

18. The computer program of claim 17, further comprising:
reading the indicator image and the meter reader information from the memory device to transmit the indicator image and the meter reader information to the mobile device when the connection signal is received even if the first day is not the meter reading date.

19. The computer program of claim 17, further comprising:
deleting an indicator image of the indicator captured in a previous month from the memory device before storing the indicator image captured this month in the memory device.
